(19) United States
(12) Patent Application Publication
(10) Pub. No.: US 2018/0260868 A1
(43) Pub. Date: Sep. 13, 2018

(54) Method of Product Transportation Device Delivery

(71) Applicants: Vaughn Peterson, Provo, UT (US); Jacob Christensen, Syracuse, UT (US); Steven Malone, Manti, UT (US)

(72) Inventors: Vaughn Peterson, Provo, UT (US); Jacob Christensen, Syracuse, UT (US); Steven Malone, Manti, UT (US)

(21) Appl. No.: 15/452,036

(22) Filed: Mar. 7, 2017

(51) Int. Cl. G06Q 30/06; G06K 9/00

(52) U.S. Cl. CPC G06Q 30/0619; G06K 9/00771; G06Q 30/0631

(57) ABSTRACT

A method for delivering a product transportation device to a customer includes detecting, with machine vision, that a customer in a brick-and-mortar store is carrying one or more items without a product transportation device to transport the one or more items. An image is obtained of the customer carrying the one or more items without a product transportation device along with a location of the customer. The image and location are sent to a mobile device of an employee of the brick-and-mortar store. The employee delivers a product transportation device to the customer location and the customer is notified of the delivery of the product transportation device for transportation of the one or more items.

### BACKGROUND

### Field of the Invention

The present invention relates to providing customer service to customers of a brick-and-mortar store including delivery of a product transportation device to the customer.

### Background of the Invention

Customers shopping at a brick-and-mortar store will often stop in to shop for a small number of items and decide not use a product transportation device such as a cart or basket. Often times the customer will forgo purchasing an extra item or two because of not having a product transportation device. Lost sales result from customers carrying products while traveling through a store as compared to customers who use a shopping cart.

### SUMMARY

A method of delivering a product transportation device to a customer includes detecting, with machine vision, that a customer in a brick-and-mortar store is carrying or has removed one or more items from a shelf without a product transportation device to transport the one-or-more items. An image is obtained of the customer carrying the one or more items without a product transportation device along with a location of the customer. The image and location are sent to a mobile device of an employee of the brick-and-mortar store. The employee delivers a product transportation device to the customer location and the customer is notified of the delivery of the product transportation device for transportation of the one-or-more items.

The method may include tracking the customer in real-time while the customer is in the brick-and-mortar store. An identity of the customer may be associated with a profile of the customer at checkout. The machine vision may use a defined camera location or a defined pixel grouping to determine a customer location identifier. One or more cameras may be used and a camera may be assigned to a particular area, isle or region within a store. If only one camera is used, pixel groupings of a camera's optical sensor may be associated with isles, regions, and/or areas of a store. Cameras may use thermal imaging in addition to optical image recognition. The machine vision may also identify the one or more items for purchase using a barcode, lettering, and/or dimensional item constraints. Machine vision may continually update the location of the customer and report the updated location to an employee of a store. If there are many customers in the store without a product transportation device, there may be a priority system set in place to determine which customers to serve first. This priority system may include the number of items the customer is carrying, whether the customer has accepted a product transportation device before, if the customer has a perks id card with the store, or any other indications that the customer would accept a product transportation device if it were sent to them.

The product transportation device may be a shopping cart, a motorized shopping cart, a basket, or any other form of a product transportation device that the store may have. The product transportation device may have a digital display. The digital display may display an image of the customer as the notification to the customer of the delivery of the empty product transportation device. The employee may also be the one to notify the customer of the product transportation device. A text may be sent to the customer as a notification of the empty product transportation device. The digital display may include advertisements related to the one or more items to be purchased. The advertisements may include coupons for items related to the one or more items to be purchased. The digital display may also include common recipe item suggestions, or sale items suggestions. The digital display may include profile options including one or more of music, shopping preferences, payment preferences, entertainment preferences, game preferences, customer feedback preferences, or advertising preferences. The method may include tracking the customer in real-time while the customer is in the brick-and-mortar store enabling updated locations of the customer to be sent to an employee as the customer moves from isle to isle. An identity of the customer may be associated with a profile of the customer at checkout by associating a payment method with a photo, email address, home address, phone number, rewards card, social media login, or a combination thereof. The machine vision may use public available Internet images to identify the customer. Such images may originate from social media websites, google, etc. The identity of the customer may be confirmed at checkout by a payment method, rewards card, or any other personal identifier supplied at the point-of-sale. The image of the customer may include one or more items to be purchased which are being carried by the customer. The empty product transportation device may further include a digital display. The digital display may further include advertisements related to the one or more items to be purchased. The advertisements may further include coupons for items related to the one or more items to be purchased. The image of the customer may be displayed on the digital display of the product transportation container as the notification to the customer of the delivery of the product transportation device. The digital display may further include profile options of the customer. The profile options may include one or more of music, shopping preferences, payment preferences, entertainment preferences, game preferences, customer feedback preferences, or advertising preferences. The product transportation device may include one or more of a shopping cart, a motorized shopping cart, or a basket. The customer location may be determined by the real-time tracking of the customer. The customer location reported to the employee may be updated if the customer changes isles within the brick-and-mortar store by resending the image of the customer with an updated customer location superimposed in the image. The notifying of the customer may be accomplished by a physical notification attached to the product transportation device. The notifying of the customer may be accomplished by the employee speaking to the customer. The notifying of the customer may be accomplished by sending a text message to a mobile device of the customer. The one or more items to be purchased may be identified by the machine vision. The identified one or more items to be purchased may be used to provide information to the customer using a digital display attached to the empty product transportation device.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a perspective view of an employee's cell phone in accordance with an embodiment of the invention;

FIG. 2 shows a flow diagram in accordance with an embodiment of the invention;

FIG. 3 shows a diagram depicting devices and methods of delivering product transportation containers to customers in accordance with an embodiment of the invention;

FIG. 4 shows an isometric view of a product transportation device in accordance with an embodiment of the invention;

FIG. 5 shows a perspective view of delivery of a product transportation device to a customer in accordance with an embodiment of the invention;

FIG. 6 shows a perspective view of delivery of a product transportation device to a customer in accordance with an embodiment of the invention;

FIG. 7 shows a diagram of devices in accordance with an embodiment of the invention;

FIG. 8 shows a perspective view of a point-of-sale transaction in accordance with an embodiment of the invention;

FIG. 9 shows a flow diagram in accordance with an embodiment of the invention; and

FIG. 10 shows a flow diagram in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings.

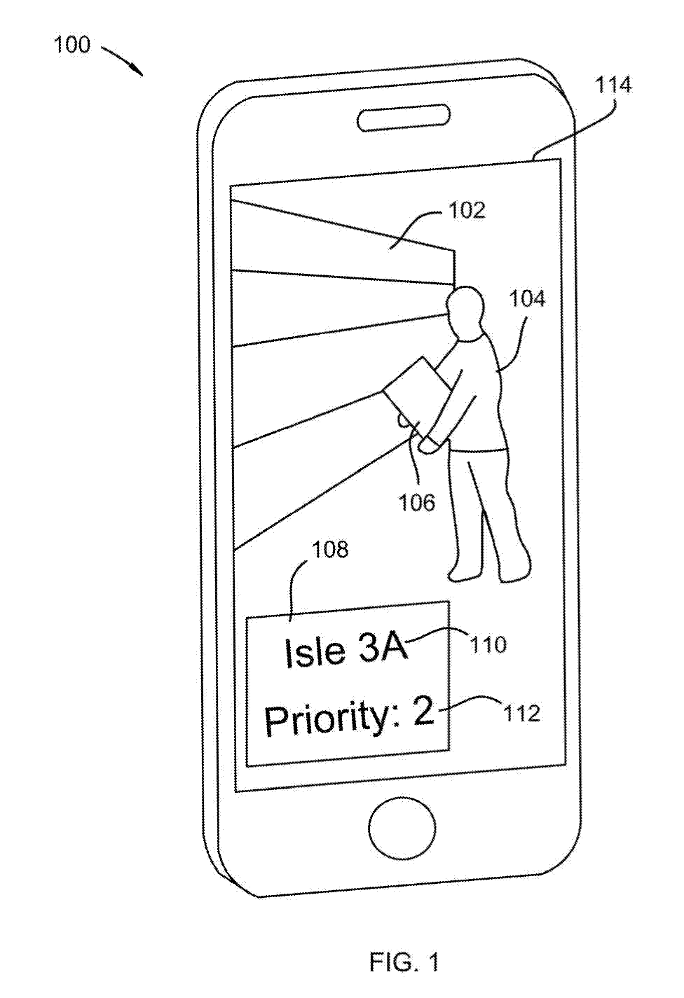

FIG. 1 shows a perspective view isometric view of an employee's cell phone 100. The cell phone 100 includes a display 114 displaying an image of customer 104 carrying one or more products 106 to be purchased. Image 116 may include an indication of a location 110 of the customer 104 carrying one or more products. An employee may be able to determine, by looking at image 116, that customer 104 does not have a product transportation device nearby. The image 116 may include a textbox 108 overlaid on image 116. The overlaid textbox may include a location 110 and a priority indication 112. The location 110 may include an isle number location of an isle 102 of a brick-and-mortar store. Textbox 108 may be overlaid on image 116 by merging data or overwriting data in an image data file. This editing of image 116 may take place before the image is sent to employee device 100 allowing a single image or a data set of a single image to be transferred the employee device 100. The employee device may comprise a cell phone, an IPad, a tablet computer, a retailer specific device such as a product labeling and scanning device, or a desktop computer. A priority code 112 may be given to a situation such as a customer standing still, a customer moving in a particular direction, a number of items a customer is carrying, a type of product a customer is carrying, or an identity of the customer. For example, a store camera may track a customer 104 and determine that the customer 104 has removed an item 106 from an isle shelf 102 and assign a priority 3. One or more cameras may employ thermal imaging in addition to poly chromatic images/video to track the customer and any items removed from a shelf. Thermal imaging cameras may detect and discriminate a product transportation device from a customer and from products to be purchased. In another example, a customer is detected carrying multiple products to be purchased and a priority of 2 is given. Various priorities may be assigned based on customer age, gender, weight, body mass index, direction of travel, size of product being carried, number of products being carried, type of product transportation device needed, or speed of movement of the customer.

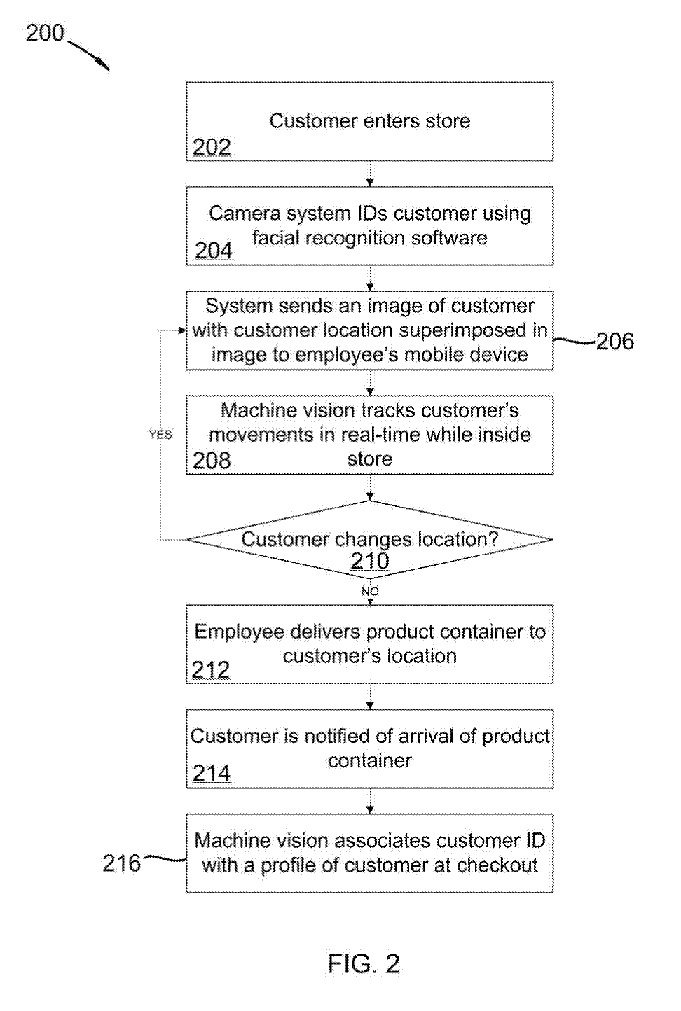

FIG. 2 shows a flow diagram in accordance with an embodiment of the invention. A customer enters store 202. Machine vision, which may include one or more camera systems, one or more computers, one or more wireless transmitters, one or more wireless receivers, one or more networks, may be used to detect a customer carrying one or more products to be purchased 204. Products to be purchased may include one or more products removed from a shelf or display. The one or more cameras may employ thermal imaging in addition to poly chromatic images to track the customer and any items removed from a shelf. Thermal imaging cameras may detect and discriminate a product transportation device from a customer and from products to be purchased. An image of the customer with a customer location superimposed in the image or connected to the image may be sent 206 to an employee's mobile device by means of wired or wireless communications. The image may be sent by text message, by email, by instant messaging, or directly through a custom program application. The machine vision may track customer's movements in real-time while a customer moves inside of the store 208. The machine vision may use a defined camera location or a defined pixel grouping to determine a customer location identifier. One or more cameras may be used and a camera may be assigned to a particular area, isle or region within a store. If only one camera is used, pixel groupings of a camera's optical sensor may be related to isles, regions, and/or areas of a store. Cameras may use thermal imaging in addition to optical image recognition. Machine vision may also identify the one or more items for purchase using barcodes, lettering, or dimensional constraints of a product. If a customer's location changes, an updated image may be sent to the employee with an updated location attached to the image. An employee may deliver a product transportation device, container, cart or basket to a customer's current location 212. A customer may be notified of an arrival of the product transportation device either by the employee, a text message, a display screen on the product transportation device, or by an audio store loud speaker broadcast 214. The machine vision may associate a customer identification with a profile of customer at product checkout 216. A customer profile may include types of products purchased, a rewards card number, frequency of visits to store, stored credit account numbers, if a product transportation device was offered to the customer, if the customer accepted the product transportation device that was offered, if the customer purchased more products after accepting a product container, and a listing of products and product types that were purchased after the product container was offered.

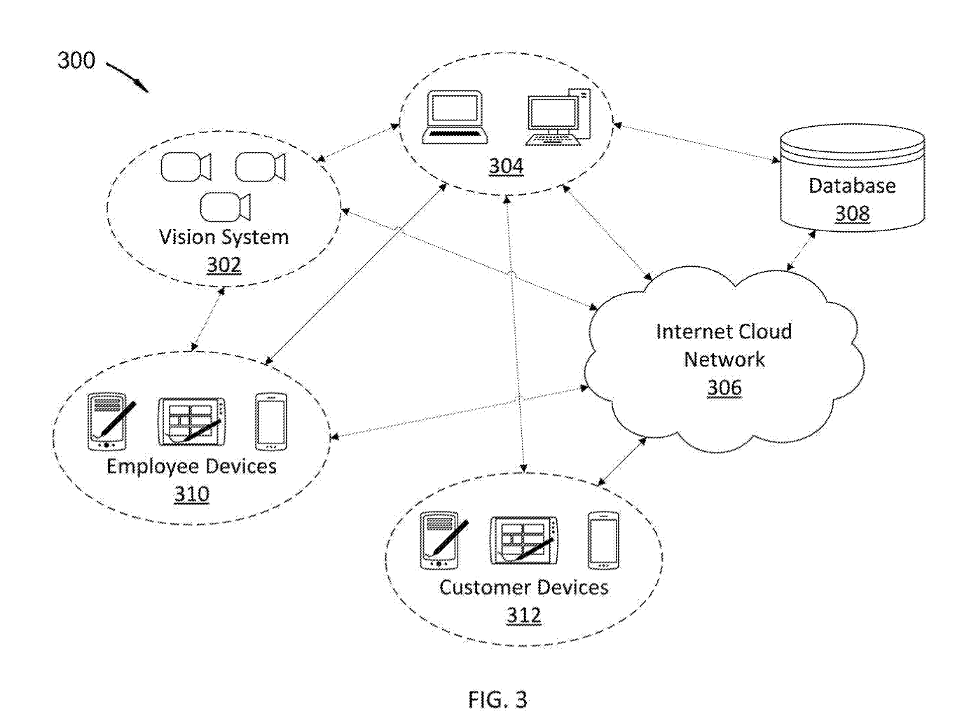

FIG. 3 shows a diagram depicting devices and methods of delivering product transportation containers to customers in accordance with an embodiment of the invention. System 300 may include machine vision system 302, one or more computers or processors 304, a cloud based wide area network 306, databases 308 including database servers, customer devices 312, and employee devices 310 which all may communicate wirelessly and/or by wire. Machine vision system 302 may include one or more cameras used to detect customers of a brick-and-mortar store carrying one or more items to be purchased. The machine vision may use a defined camera location or a defined pixel grouping to determine a customer location identifier. One or more cameras may be used and a camera may be assigned to a particular area, isle or region within a store. If only one camera is used, pixel groupings of a camera's optical sensor may be related to isles, regions, and/or areas of a store. Cameras may use thermal imaging in addition to optical image recognition. The machine vision may also identify the one or more items for purchase using a barcode, lettering, or dimensional constraints. One or more computers 302 may be connected wirelessly or by wire to each camera of vision system 302. One or more cameras may employ thermal imaging in addition to poly chromatic images to track the customer and any items removed from a shelf. Thermal imaging cameras may detect and discriminate a product transportation device from a customer and from products to be purchased. Computers 304 may provide processing and data storage allowing tracking and identification of customers and items to be purchased being carried by the customers. Computers 304 may detect customers carrying items by comparing image data of customers without carrying items to image data of customers carrying items to be purchased. Alternatively, or additionally, products may be detected by cameras 302 and computers 304 that are removed from off of shelves in a store and tracked in order to determine if the products are placed in a shopping cart, basket or other product transportation container. If the products being tracked by vision system 302 are never placed in a product transportation container, then it may be assumed that the products are being carried by the customer. This may be verified as an employee receives an image at an employee device and confirms whether the customer needs a product transportation container delivered by viewing the image. Computers 304 may form a local area network within a company with multiple locations with a shared database. Wide area network 306 may include the Internet, cloud based servers and databases, which may be local or remote from a store using vision system 302. Computers 304 may transmit and receive data over a local area network or a wide area network. Digital image processing and tracking may be performed on a cloud based server or on local computers. In one embodiment, a customer enters a brick-and-mortar store to purchase a single item and decides not obtain a shopping cart for single item to be purchased. As the customer enters the store a vision system 302 tracks the customer and determines that the customer does not have a shopping cart. The customer then notices a sale on a particular product and starts looking at the sale item. The machine vision system 302 recognizes that the customer has stopped to look at products to be purchased and may or may not be holding an item to be purchased. An electronic image of the customer is taken by the machine vision system 302/304 looking at or handling specific items to be purchased. The image obtained is overlaid with a location of the customer using computers 304 or cloud processing 306 and the image is sent to an employee device 310. The employee may determine, by looking at the picture, that the customer needs a shopping cart and deliver a shopping cart to the customer and offer a shopping cart to the customer by speaking to the customer and delivering the shopping cart. In another embodiment, the machine vision system 302/304 recognizes or identifies a customer and accesses a customer profile stored in a local or remote database and determines if the customer has preferences for receiving a shopping cart set in his or her profile. An employee may leave a shopping cart in a location close to the customer and an electronic device 312 connected to the shopping cart may identify the customer and invite them to take the basket. The electronic device may audibly and/or visibly invite the customer to use the provided cart. A location of the shopping cart, with the attached electronic customer device, may be associated with a customer profile by machine vision system 302 and/or computers 304. A global positioning system within customer device 312 may be used to report location information to network 304 or network 306 in order to associate a shopping cart with a customer profile. The customer, when presented a shopping cart, may take the shopping cart and decide to purchase more than the single item the customer originally planned on purchasing. The electronic customer device 312 on the shopping cart may contain advertisements, coupons, and suggestions related to product(s) the customer is looking at, carrying, or planning to purchase.

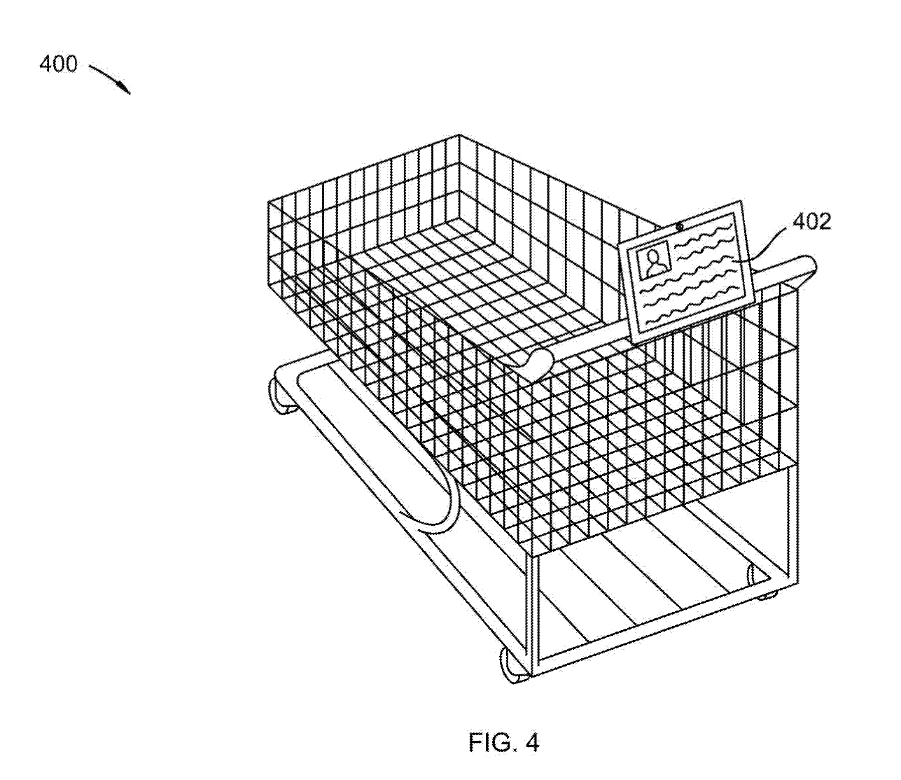

FIG. 4 is an isometric view of a product transportation device in accordance with an embodiment of the invention. Product transportation device 400 is shown with an electronic customer device 402. Customer device 402 may contain a camera, processor, wireless transceiver, a display, and programming allowing device 402 to interact with the customer and vision system 302, computers 304, and network 306 (of FIG. 3).

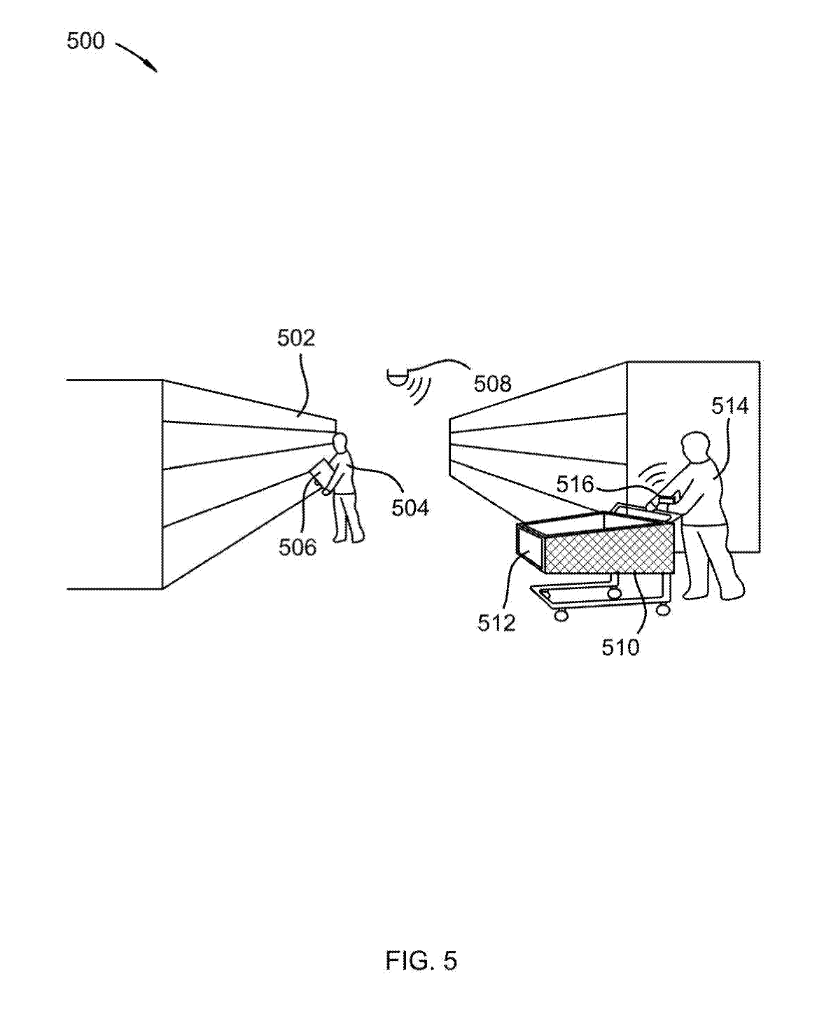

FIG. 5 is a perspective view of delivery of a product transportation device 510 to a customer 504 in accordance with an embodiment of the invention. Machine vision system 508 detects customer 504 carrying one or more products to be purchased 506 or removal of one or more products from shelf 502, and captures an image of the customer 504 and the one or more products 506 to be purchased and sends the image along with a location of the customer attached to the image to employee device 516. Employee 514 looks at the image and decides that customer 504 needs a product transportation device. Employee 514 delivers transportation device shopping cart 510 to customer 504. Employee 514 may verbally notify customer 504 of delivery of a product transportation device shopping cart 510. Notification may include employee 514 asking customer 504 if they want the product transportation device/shopping cart and/or may the shopping cart customer device 512 may display something like “available shopping cart” or “unused shopping cart” allowing the customer to obtain verbal and/or non-verbal notification of the delivery of the shopping cart 510.

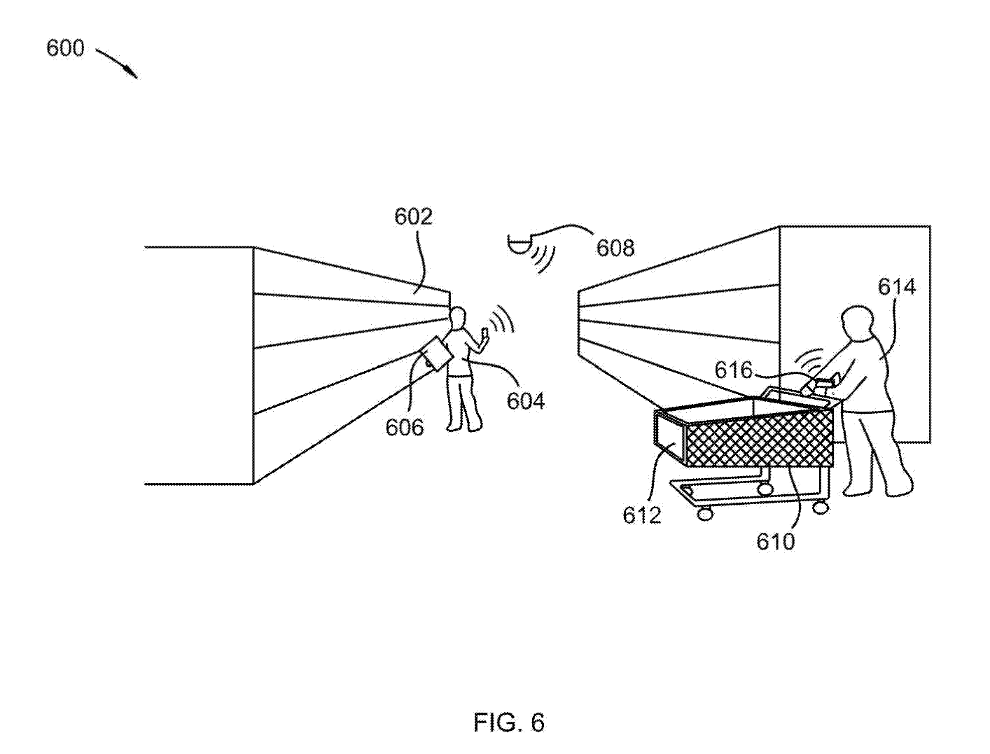

FIG. 6 is a perspective view of delivery of a product transportation device 610 to a customer 604 in accordance with an embodiment of the invention. Machine vision system 608 detects customer 604 carrying one or more products to be purchased 606 or removal of one or more products from shelf 602, and captures an image of the customer 604 and the one or more products 606 to be purchased and sends the image along with a location of the customer attached to the image to employee device 616. Employee 614 looks at the image and decides that customer 604 needs a product transportation device 610. Customer 604 has an electronic device which has a store shopping software application that receives an automated notification asking if the customer would like a cart that is at the end of the isle. Employee 614 may wait for a response or may deliver transportation device shopping cart 610 to customer 604. Employee 614 may verbally notify customer 604 of delivery of a product transportation device shopping cart 610. Notification may include employee 614 asking customer 604 if they want the product transportation device/shopping cart and/or may the shopping cart customer device 612 may display something like “available shopping cart” or “unused shopping cart” allowing the customer to obtain verbal and/or non-verbal notification of the delivery of the shopping cart 610.

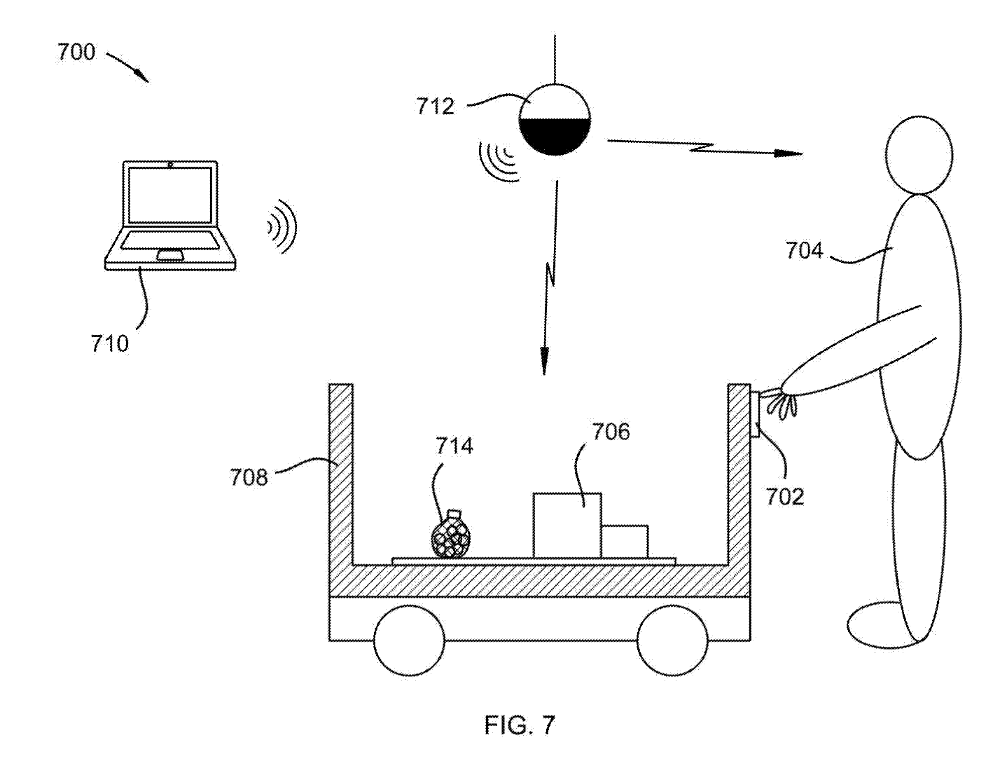

FIG. 7 shows devices in accordance with an embodiment of the invention. After customer 704 receives product transportation device 708, machine vision system 712 may recognize items 714 and 706 while being transported by product transportation device 708 or as customer 704 removes items from a shelf or holds product before adding the product to cart 708. Computer 710 may be in communication with customer device 702 and/or machine vision 712 and cause consumer device 702 to display products or advertisements related to products in the product transportation device 708. Related products may include common products that others purchased along with specific products or group of products in/on the transportation device 708. Machine vision system may communicate with computer 710 and/or customer device 702 in order to cause suggested product purchases, directions to other products within the store, store shopping lists of the customer, and an identity of the customer 704 including a customer profile to display or load onto customer device 702.

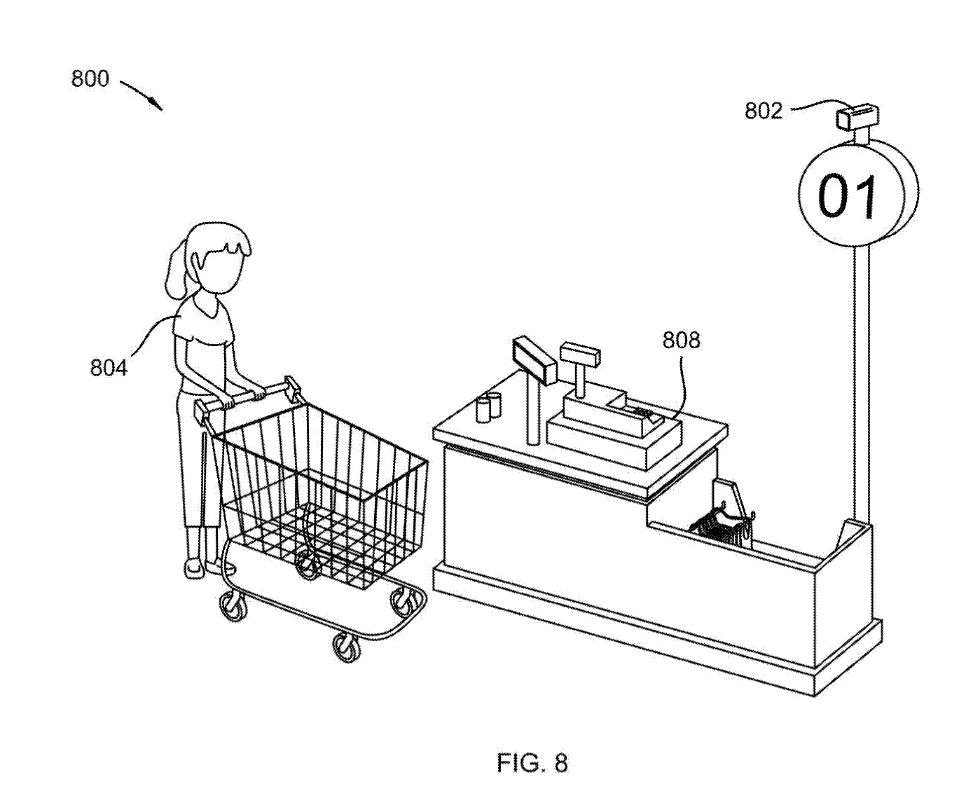

FIG. 8 is a perspective view of a point-of-sale transaction in accordance with an embodiment of the invention. An image of customer 804 may be taken by camera 802 at a point-of-sale. This image may be used for future identification and association of customer 804 with purchases made and with an in-store profile. Point-of-sale machine 808 may additionally associate a name, rewards card, payment card, email address, or phone number with a picture taken by camera 802 for customer profile data.

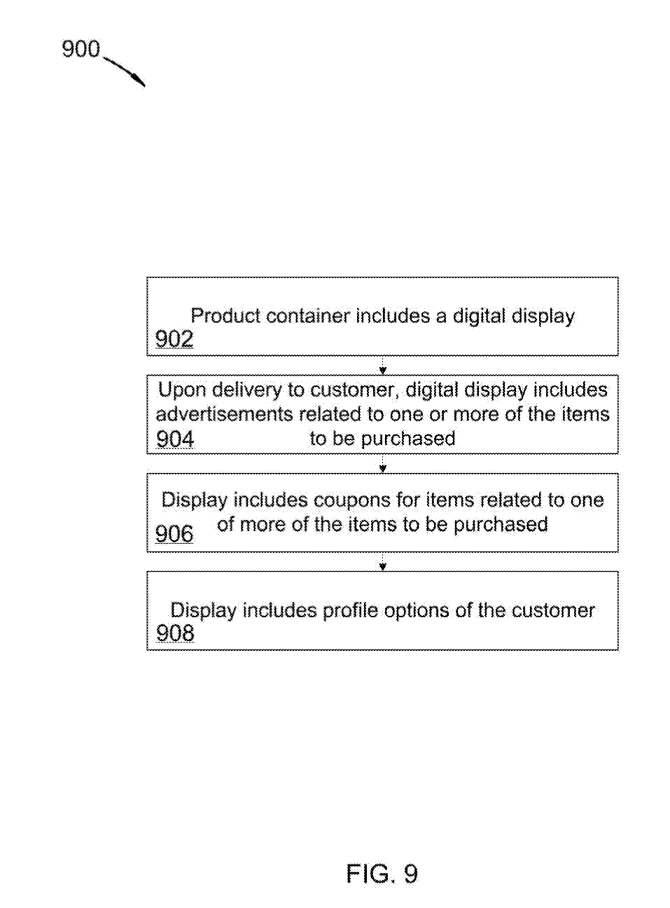

FIG. 9 is a flow diagram in accordance with an embodiment of the invention. An example of how a digital display on a product container may be used will be given in relation to FIG. 9. A product container in use by a customer includes a digital device 902. The digital device is used to give specific advertisements to the customer related to products to be purchased 906. Products to be purchased may include an online shopping list created by the customer previous shopping at the store, products related to products in a product container/shopping cart, or anticipated purchases based on a historical shopping record of the customer. A profile of customer may be loaded and displayed on the digital device on the product container 908.

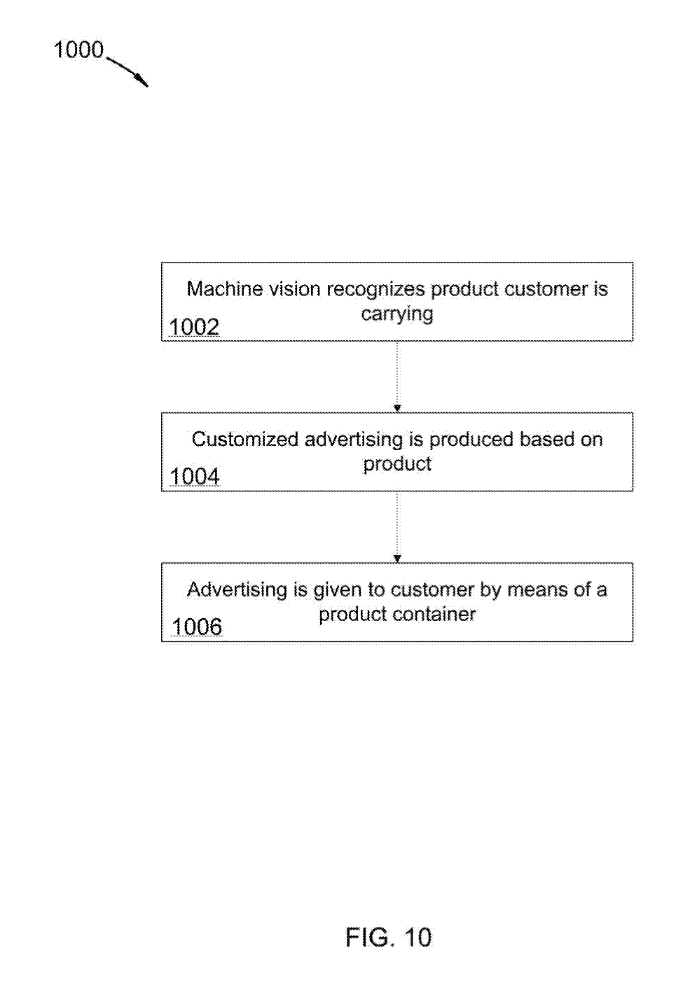

FIG. 10 is a flow diagram in accordance with an embodiment of the invention. A machine vision system recognizes one or more products a customer is carrying 1002, by means described previously, and custom advertising is generated and given to the customer 1004. The custom advertising may be given to the customer by means of a customer device on a product container 1006 or by a printed and hand delivered advertisement. The advertisement may include coupons and locations of items related to the advertisements/coupons.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of delivering a product transportation device comprising:
detecting, with machine vision, that a customer in a brick-and-mortar store is carrying one or more items without the product transportation device;
sending an image of the customer including a customer location identifier to a mobile device of an employee of the brick-and-mortar store;
delivering the product transportation device to the customer location; and
notifying the customer of the delivery of the product transportation device for transportation of the one or more items.

2. The method of claim 1, wherein the machine vision tracks the customer in real-time while the customer is in the brick-and-mortar store.

3. The method of claim 1, wherein the machine vision associates an identity of the customer with a profile of the customer at checkout.

4. The method of claim 1, wherein the machine vision uses a defined camera location or a defined pixel grouping to determine the customer location identifier.

5. The method of claim 4, wherein the identity of the customer is confirmed at checkout.

6. The method of claim 1, wherein the image of the customer includes the one or more items to be purchased.

7. The method of claim 1, wherein the product transportation device further includes a digital display.

8. The method of claim 7, wherein the digital display further includes advertisements related to the one or more items to be purchased.

9. The method of claim 8, wherein the advertisements further include coupons for items related to the one or more items to be purchased.

10. The method of claim 7, wherein the image of the customer is displayed on the digital display as the notification to the customer of the delivery of the product transportation device.

11. The method of claim 7, wherein the digital display further includes profile options of the customer.

12. The method of claim 11, wherein the profile options include one or more of music, shopping preferences, payment preferences, entertainment preferences, game preferences, customer feedback preferences, or advertising preferences.

13. The method of claim 1, wherein the product transportation device includes one or more of a shopping cart, a motorized shopping cart, or a basket.

14. The method of claim 6, wherein the one or more items to be purchased are identified by the machine vision.

15. The method of claim 2, wherein the customer location reported to the employee is updated if the customer changes isles within the brick-and-mortar store by resending the image of the customer with an updated customer location superimposed in the image.

16. The method of claim 1, wherein the notifying of the customer is accomplished by a physical notification attached to the product transportation device.

17. The method of claim 1, wherein the notifying of the customer is accomplished by the employee speaking to the customer.

18. The method of claim 1, wherein the notifying of the customer is accomplished by sending a text message to a mobile device of the customer.

19. The method of claim 14, wherein the identified one or more items to be purchased are used to provide information to the customer using a digital display attached to the product transportation device.

20. The method of claim 19, wherein the information is one or more of related item suggestions, recipe suggestions, common recipe item suggestions, or sale items suggestions.
